(19) United States
(12) Patent Application Publication
(10) Pub. No.: US 2018/0323413 A1
(43) Pub. Date: Nov. 8, 2018

(54) APPARATUS FOR PROVIDING A BARRIER BETWEEN BATTERY MODULES

(71) Applicant: Jaguar Land Rover Limited, Whitley, Coventry, Warwickshire (GB)

(72) Inventor: Stephen NICHOLLS, Whitley, Coventry (GB)

(21) Appl. No.: 15/770,607

(22) PCT Filed: Dec. 9, 2016
(86) PCT No.: PCT/EP2016/080389

§ 371 Date: Apr. 24, 2018

(30) Foreign Application Priority Data
Dec. 9, 2015 (GB) 1521661.7

(51) Int. Cl. H01M 2/10; B60L 11/18

(52) U.S. Cl. CPC H01M 2/1094; H01M 2/1077; H01M 2220/20; B60L 11/1879; H01M 2200/10; B60L 11/187

(57) ABSTRACT

An apparatus for providing a barrier between modules of a battery in a vehicle wherein the apparatus comprises: a thermally insulating material; and an intumescent material overlaying the thermally insulating material.

### TECHNICAL FIELD

The present disclosure relates to an apparatus for providing a barrier between battery modules in a vehicle and particularly, but not exclusively to an apparatus for providing a barrier between modules of a battery in an electric vehicle arranged to contain and to prevent the spreading of a thermal event between adjacent battery modules. Aspects of the invention relate to an apparatus, a system and to a vehicle.

### BACKGROUND

Batteries within electric vehicles (EV) or hybrid electric vehicles (HEV) conventionally comprise a plurality of small modules. Each module consists of a build-up of multiple electrical cells each comprising two conductive electrodes which are separated by a thin separator. The sheets of electrodes and separator are arranged in stacks and then rolled up or compressed to form a battery module.

Failure of modules of the battery can occur for a variety of reasons such as overcharging of the battery or contaminations during manufacture.

If one module of a battery fails this can rapidly lead to short circuits to other modules of the battery and large increases in temperature. This can lead to a thermal event within the battery.

It is an aim of the present invention to address disadvantages associated with such battery modules.

### SUMMARY OF THE INVENTION

Aspects and embodiments of the invention provide an apparatus, a system and a vehicle as claimed in the appended claims.

According to an aspect of the invention, there is provided an apparatus for providing a barrier between modules of a battery in a vehicle wherein the apparatus comprises: a thermally insulating material; and an intumescent material overlaying the thermally insulating material.

An advantage associated with the apparatus is that it acts as a good thermal insulator when configured between neighbouring modules of a battery, thus preventing the propagation of a thermal event between neighbouring battery modules. The thermal event may relate to a fire or to an increase in temperature.

The intumescent material may completely cover the thermally insulating material. This further improves the thermal insulation characteristics of the apparatus, in the event of a fire or an increase in temperatures.

The thermally insulating material may be provided as a thin layer. This ensures that the apparatus is lightweight and does not significantly increase the mass of the vehicle. This also enables gaps to be provided between modules of the battery which may allow for improved ventilation.

The thermally insulating material may comprise a fibre based insulator. This ensures that the apparatus is lightweight and may also provide good insulation between modules of the battery.

The apparatus may comprise a plurality of vertical sections arranged to be positioned between modules of a battery. This enables an insulating barrier to be provided between each of the different modules of the battery.

The apparatus may comprise a horizontal section arranged to overlay the modules of the battery. This provides an insulating barrier between the battery and other parts of the vehicle. This also provides insulation between modules of a battery.

The apparatus may comprise a gap between the vertical sections and at least part of the horizontal section. The gap prevents over heating of the modules of a battery for example by allowing air flow between the modules of the battery, and pressure build up around the modules of the battery.

The intumescent material may be arranged to seal the gap in response to a thermal event. This provides thermal insulation between battery modules in response to a thermal event, and helps to reduce the risk of the thermal event spreading between modules of the battery.

The apparatus comprises a side member arranged to extend along a side of a battery. Where the apparatus includes vertical sections and a side member the apparatus may comprise a gap between at least part of at least one of the vertical sections and at least part of the side member. The gap prevents over heating of the modules of a battery, for example by allowing air flow between the modules of the battery, and pressure build up around the modules of the battery.

The intumescent material may be arranged to seal the gap in response to a thermal event.

This provides thermal insulation between battery modules in response to a thermal event, and helps to reduce the risk of the thermal event spreading between modules of the battery.

The apparatus may form a closed wall around a module of a battery and the apparatus may comprise a valve or a restrictor orifice. The valve or restrictor orifice allow for built up gases to be expelled from around the module to a vent point via suitable means. The intumescent material may be arranged to seal the valve or restrictor orifice to prevent any airflow therethrough in response to a thermal event to help to reduce the risk of the thermal event spreading between modules of the battery.

According to another aspect of the invention, there is provided a system comprising an apparatus and a battery as described in the preceding paragraphs. This aspect of the invention benefits from the same advantages as mentioned previously in relation to the apparatus.

According to another aspect of the invention, there is provided a vehicle comprising an apparatus as described in the preceding paragraphs.

According to a further aspect of the invention there is provided an apparatus configured to provide a thermally insulating barrier between modules of a battery in a vehicle.

According to still another aspect of the invention, there is provided an apparatus comprising intumescent material arranged to be positioned between modules of a battery in a vehicle.

According to a further aspect of the invention, there is provided an apparatus for providing a barrier between modules of a battery in a vehicle, wherein the apparatus comprises: a thermally insulating means; and intumescent means overlaying the thermally insulating means.

The thermally insulating means may comprise a thermally insulating material. The intumescent means may comprise an intumescent material.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 is a perspective illustration of a vehicle in accordance with an embodiment of the invention;

FIG. 2 is a perspective illustration of a portion of an apparatus, in accordance with an embodiment of the present invention;

FIG. 3 is a plan view illustration of an apparatus in accordance with an embodiment of the present invention;

FIG. 4 is a perspective illustration of the apparatus of FIG. 3; and

FIG. 5 is a cross section illustration of the apparatus of FIGS. 3 and 4.

### DETAILED DESCRIPTION

Examples of the present disclosure relate to an apparatus which may be configured to provide a barrier between modules of a battery within a vehicle. For instance, some examples relate to an apparatus which may be used to provide a barrier between modules of a battery in a vehicle such as an electric vehicle (EV) or a hybrid electric vehicle (HEV).

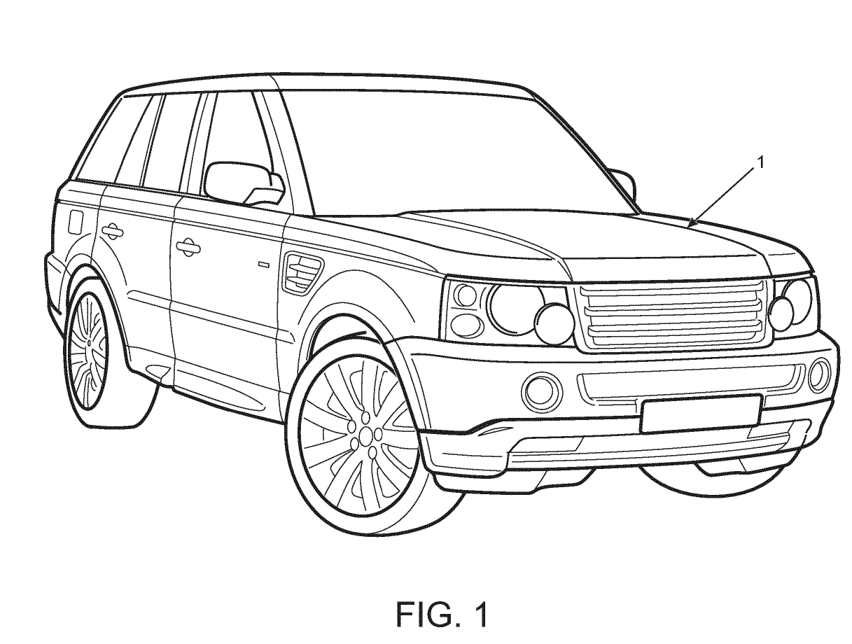

FIG. 1 illustrates an example vehicle 1 which may comprise apparatus according to examples of the present disclosure. It is to be appreciated that the vehicle 1 of FIG. 1 is provided as an example and that examples of the disclosure may be provided in any vehicle provided with a modular battery.

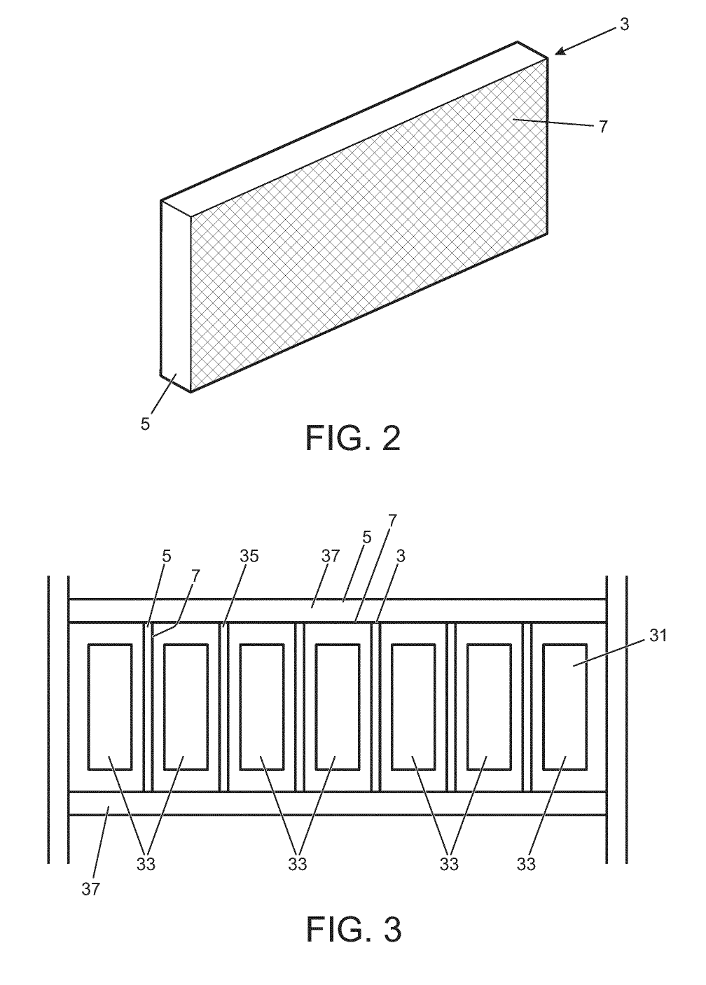

FIGS. 2 to 5 illustrate examples of the apparatus 3 for providing a barrier between modules 33 of a battery 31 within a vehicle 1. The apparatus 3 comprises: a thermally insulating material 5; and an intumescent material 7 overlaying the thermally insulating material 5.

FIG. 2 illustrates a perspective view of a portion of an example apparatus 3, in accordance with an embodiment. The example portion of FIG. 2 could be used as a vertical section 35 which could be positioned between modules 33 of a battery 31, or a horizontal section 41, which could be provided overlaying modules 33 of a battery 31.

The portion of the apparatus 3 comprises a thin layer of thermally insulating material 5. The thin layer may have a thickness of the order of several millimeters.

The thermally insulating material 5 may comprise any material which has a low thermal conductivity. In some examples, the thermally insulating material 5 may also be electrically insulating so that the material also has a low electrical conductivity. The thermally insulating material 5 may be a light weight material such that the apparatus 3 does not significantly increase the mass of the vehicle 1. The thermally insulating material 5 may comprise a fibre based material, a thermoplastic or any other suitable material.

The thermally insulating material 5 may provide a substrate on which an intumescent material 7 is provided. In the example of FIG. 2, the thermally insulating material 5 is provided as a flat or substantially flat substrate. It is to be appreciated that the thermally insulating material 5 could be provided in other shapes in other example apparatus.

In the example apparatus 3 of FIG. 2, the intumescent material 7 is provided as a coating overlaying the thermally insulating material 5. The intumescent material 7 may be provided as a thin coating on the surface of the insulating material 5. In some examples, the intumescent material 7 may completely cover the surface of the thermally insulating material 5.

The intumescent material 7 may comprise any material, which is configured to expand when heated. The intumescent material 7 may be inert at low temperatures so that an increase in temperature due to normal operation of a battery does not cause the intumescent material 7 to expand. A low temperature may be a temperature at which the vehicle 1 and the battery 31 operate normally.

The intumescent material 7 may be arranged to expand in response to a thermal event. The thermal event could be an increase in temperature to above a threshold. The threshold temperature at which the intumescent material 7 expands may be selected to ensure that the expansion of the intumescent material 7 occurs before the increase in temperature causes failure of adjacent modules 33 of the battery 31.

The intumescent material 7 may comprise a water based material or an epoxy based material or any other suitable intumescent material 7.

FIG. 3 illustrates a plan view of an example apparatus 3. The apparatus 3 forms a system 39 with a battery 31. The apparatus 3 may comprise a plurality of portions as illustrated in FIG. 2. The portions are positioned between modules 33 of battery 31. In the example of FIG. 3 the battery 31 comprises seven modules 33. It is to be appreciated that any number of modules 33 could be provided in other examples of the disclosure.

In the example of FIG. 3, the apparatus 3 comprises a plurality of vertical sections 35. Each of the vertical sections 35 may comprise an intumescent material 7 overlaying a thermally insulating material 5. The intumescent material 7 may be provided on either side of the thermally insulating material 5.

The vertical sections 35 are positioned between modules 33 of the battery 31. The vertical sections 35 provide barriers between adjacent modules 33 of the battery 31.

The vertical sections 35 may be thinner than the gap between adjacent modules 33 of the battery 31. This may enable an air gap to be provided between the vertical sections 35 and the modules 33 of the battery 31.

In the example of FIG. 3, the apparatus 3 also comprises side members 37. The side members may extend along a side of the battery 31. The side members 37 may be coupled to the vertical sections 35.

The side members 37 may also comprise an intumescent material 7 overlaying a thermally insulating material 5. In some examples, the intumescent material 7 may only be provided on the side of the side member 37 which is adjacent to the modules 33 of the battery 31.

In another example, the apparatus 3 may comprise a gap (not shown) between at least part of the vertical sections 35 and at least part of the side members 37. The gap may prevent over heating of the module 33 of the battery 31, and may also prevent pressure build up around the module 33 of the battery 31. The intumescent material 7 may be arranged to fill the gap in response to a thermal event. This may prevent the thermal event from spreading between different modules 33 of the battery 31.

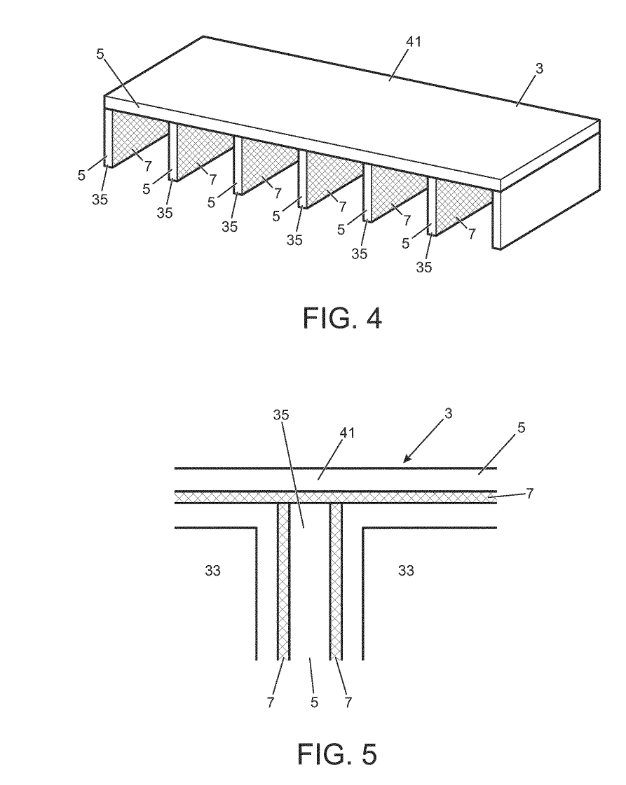

FIG. 4 illustrates a perspective view of example apparatus 3. In the example of FIG. 4 the apparatus 3 comprises a plurality of vertical sections 35 and also a horizontal section 41. The horizontal section 41 may be arranged to overlay modules 33 of the battery 31.

In the example of FIG. 4, the horizontal section 41 also comprises an intumescent material 7 overlaying a thermally insulating material 5. The horizontal section 41 may be formed from the same insulating material 5 and intumescent material 7 as the vertical sections 35.

In the example of FIG. 4, the horizontal section 41 is provided overlaying the vertical sections 35 so that the horizontal section is in contact with the vertical sections. In the example of FIG. 4 there is no gap between the vertical sections 35 and the horizontal section 41. The apparatus 3 may form a closed wall around the modules 33 of the battery 31. In such examples one or more valves or restrictor orifices may be provided within the apparatus 3 to allow for built up gases to be expelled and to prevent a build up of pressure.

In other examples, the apparatus 3 may comprise a gap (not shown) between at least part of the vertical sections 35 and at least part of the horizontal section 41. The gap may prevent over heating of the module 33 of the battery 31, and may also prevent pressure build up around the module 33 of the battery 31. The intumescent material 7 may be arranged to fill the gap in response to a thermal event. This may prevent the thermal event from spreading between different modules 33 of the battery 31.

FIG. 5 illustrates a cross section of the example apparatus 3 of FIG. 4.

FIG. 5 illustrates the apparatus 3 in a non-activated state. In the non-activated state the apparatus 3 may be at an ambient temperature in which the intumescent material 7 is not expanded. In this state the intumescent material 7 comprises a very thin coating. The thickness of the intumescent material 7 may be much less than the thickness of the insulating material 5.

In the example of FIG. 5 the intumescent material 7 is provided on the surfaces of the insulating material 5 that are adjacent to the modules 33 of the battery 31. The intumescent material 7 is provided on either side of the vertical section 35 and on the underside of the horizontal section 41.

In the non-activated state the apparatus 3 may maintain the temperature of the battery 31. The battery 31 of an EV or HEV may have an optimum operating temperature range of between 20 to 30° C. As the apparatus 3 is made of an insulating material 5, the insulating material may keep the battery 31 at this operating temperature. For instance, if the vehicle 1 stops for a short period of time, the apparatus 3 will help to keep the battery warm. This may increase the efficiency of the vehicle 1.

In the activated state the apparatus 3 may prevent a thermal event from spreading between modules 33 of a battery 31 and/or may increase the time it takes for a thermal event to spread between adjacent modules 33 of a battery.

If the temperature rises above the activation temperature of the intumescent material then the intumescent material 7 will expand to create a thermal barrier. In the activated state the thickness of the intumescent material 7 may be larger than the thickness of the insulating material 5. The expansion of the intumescent material 7 may restrict the conduction of heat between adjacent modules 33 of the battery 31 which will help to prevent the thermal event from spreading.

Therefore, the apparatus 3 also helps to improve the safety of the vehicle 1.

Within the context of the present disclosure it is to be understood that where a structural feature has been described, it may be replaced by means for performing one or more of the functions of the structural feature whether that function or those functions are explicitly or implicitly described.

The term “comprise” is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this brief description, reference has been made to various examples. The description of features or functions in relation to an example indicates that those features or functions are present in that example. The use of the term “example” or “for example” or “may” in the text denotes, whether explicitly stated or not, that such features or functions are present in at least the described example, whether described as an example or not, and that they can be, but are not necessarily, present in some of or all other examples. Thus “example”, “for example” or “may” refers to a particular instance in a class of examples. A property of the instance can be a property of only that instance or a property of the class or a property of a sub-class of the class that includes some but not all of the instances in the class. It is therefore implicitly disclosed that a features described with reference to one example but not with reference to another example, can where possible be used in that other example but does not necessarily have to be used in that other example.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus for providing a barrier between modules of a battery in a vehicle, wherein the apparatus comprises:
a thermally insulating material;
an intumescent material overlaying the thermally insulating material;
a plurality of vertical sections arranged to be positioned between the modules; and
a horizontal section arranged to overlay the modules,
wherein the apparatus comprises a first gap between at least part of at least one of the plurality of vertical sections and at least part of the horizontal section, and
wherein the intumescent material is arranged to seal the first gap in response to a thermal event.

2. The apparatus as claimed in claim 1, wherein the intumescent material completely covers the thermally insulating material.

3. The apparatus as claimed in claim 1, wherein the thermally insulating material is a thin layer.

4. The apparatus as claimed in claim 1, wherein the thermally insulating material comprises a fiber based material.

5-8. (canceled)

9. The apparatus as claimed in claim 1, wherein the apparatus comprises a side member arranged to extend along a side of the battery.

10. The apparatus as claimed in claim 9, wherein the apparatus comprises a second gap between at least part of at least one of the plurality of vertical sections and at least part of the side member.

11. The apparatus as claimed in claim 10, wherein the intumescent material is arranged to also seal the second gap in response to the thermal event.

12-13. (canceled)

14. A system, comprising:
a battery comprising modules; and
an apparatus, comprising:
a thermally insulating material;
an intumescent material overlaying the thermally insulating material;
a plurality of vertical sections arranged to be positioned between the modules of the battery; and
a horizontal section arranged to overlay the modules of the battery,
wherein the apparatus comprises a first gap between at least part of at least one of the plurality of vertical sections and at least part of the horizontal section, and
wherein the intumescent material is arranged to seal the first gap in response to a thermal event.

15. A vehicle comprising the apparatus as claimed in claim 1.

16-18. (canceled)
